(19) United States
(12) Patent Application Publication
(10) Pub. No.: US 2025/0305324 A1
(43) Pub. Date: Oct. 2, 2025

(54) DOOR LOCK AND ELECTRICAL APPLIANCE INCLUDING SAME

(71) Applicant: ILLINOIS TOOL WORKS INC., GLENVIEW, IL (US)

(72) Inventors: Dongxuan WANG, Dongguan City (CN); Yukun LIU, Dongguan City (CN)

(73) Assignee: ILLINOIS TOOL WORKS INC., GLENVIEW, IL (US)

(21) Appl. No.: 19/092,383

(22) Filed: Mar. 27, 2025

(30) Foreign Application Priority Data
Mar. 29, 2024 (CN) 202410381056.X
Mar. 21, 2025 (CN) 2025103444996

(51) Int. Cl. E05B 65/00; A47L 15/42; D06F 34/20; D06F 39/14; D06F 103/40

(52) U.S. Cl. CPC E05B 65/00; A47L 15/4259; A47L 15/4274; D06F 34/20; D06F 39/14; D06F 2103/40

(57) ABSTRACT

A door lock and an electrical appliance includes a main slider, an operating circuit and an operating switch, a sensing circuit and a sensing switch, and a switch box. The operating circuit and the operating switch are arranged inside the switch box, and the sensing circuit and the sensing switch are arranged outside the switch box. The door lock of the present application includes the sensing circuit and the sensing switch to allow the electrical appliance to independently indicate the states of the door and the door hook of the electrical appliance. The sensing circuit and sensing switch of the door lock of the present application are arranged outside the switch box and are separated from the operating circuit, which avoids the arrangements of both high-voltage and low-voltage power sources inside the switch box, thereby improving the reliability of the sensing circuit and the operating circuit.

### CROSS-REFERENCE TO RELATED APPLICATIONS

Chinese Patent Application No. CN 202410381056.X, filed on 29 Mar. 2024, the priority document corresponding to this invention, and Chinese Patent Application No. CN 2025103444996, filed on 21 Mar. 2025; to which a foreign priority benefit is claimed to each under Title 35, United States Code, Section 119, and their entire teachings are incorporated, by reference, into this specification.

### BACKGROUND OF THE INVENTION

### Field of the Invention

The present disclosure relates to the field of door locks, and in particular to a door lock and an electrical appliance including same.

### Discussion of Related Art

Currently, doors of electrical appliances, such as washing machines, are locked and connected to panels of the electrical appliances by means of door locks. The door lock is mounted to the panel of the electrical appliance, and a locking hole is provided on the door lock. When a door hook mounted on the door of the electrical appliance is inserted into the locking hole, a locking device of the door lock can lock the door hook to lock and connect the door of the electrical appliance to the panel of the electrical appliance. The door lock normally further includes a switch box in which a connection terminal of an operating circuit is located. When the door of the electrical appliance is locked and connected to the panel of the electrical appliance, the locking device of the door lock can be connected to the connection terminal of the operating circuit, so as to enable activation of the electrical appliance.

Some existing door locks further include a sensing device for detecting a state of the door lock, the sensing device can be linked with the operating circuit to ensure that the connection terminal of the operating circuit is connected after the door lock comes into a locked state, thereby increasing the reliability of activation of the electrical appliance.

### SUMMARY OF THE INVENTION

Through in-depth research, the inventors of the present disclosure found that a sensing device is normally connected to a low-voltage power source, while an operating circuit is normally connected to a high-voltage power source, resulting an unreliability of a door lock due to a linkage between the sensing device and the operating circuit.

In order to solve at least one of the above technical problems, in a first aspect, the present disclosure provides a door lock, comprising a main slider, an operating circuit and an operating switch, a sensing circuit and a sensing switch, and a switch box. The main slider is able to be driven by a door hook to reciprocate in a first direction. The operating switch connects or disconnects the operating circuit based on a position of the main slider. The sensing switch connects or disconnects the sensing circuit based on the position of the main slider. The operating circuit and the operating switch are disposed inside the switch box, and the sensing circuit and the sensing switch are disposed outside the switch box.

According to the first aspect described above, a power source of the operating circuit is a high-voltage power source, and a power source of the sensing circuit is a low-voltage power source.

According to the first aspect described above, the main slider has a locked position and a released position. The door lock further includes a sensing switch driving member, the sensing switch driving member being configured to switch on the sensing switch in response to the main slider being in the released position, thereby connecting the sensing circuit; and to switch off the sensing switch in response to the main slider being in the locked position, thereby disconnecting the sensing circuit.

According to the first aspect described above, the main slider reciprocates in the first direction between the locked position and the released position, and the sensing switch driving member includes a switch slider, where the main slider is able to drive the switch slider to move in the first direction.

According to the first aspect described above, the sensing switch includes a first contact terminal and a second contact terminal, and the sensing switch driving member comprises an elastic piece, the elastic piece being made of a conductive material. The elastic piece is connected to the switch slider so as to move in the first direction with the switch slider, where the sensing switch driving member is configured such that as the main slider drives the switch slider to move, the elastic piece is able to come into contact with the first contact terminal and the second contact terminal so as to conduct the first contact terminal and the second contact terminal; or the elastic piece is able to move away from at least one of the first contact terminal and the second contact terminal so as to disconnect the first contact terminal and the second contact terminal.

According to the first aspect described above, the elastic piece includes a pair of legs, the pair of legs being formed by obliquely extending away from each other in the first direction, where a distance between the pair of legs in a second direction is set such that a maximum distance is greater than a distance between the first contact terminal and the second contact terminal, and a minimum distance is less than the distance between the first contact terminal and the second contact terminal.

According to the first aspect described above, each leg of the pair of legs further includes an arch portion, the arch portion of each leg of the pair of legs arching in opposite directions, where the elastic piece is configured to come into contact with the first contact terminal and the second contact terminal at the arch portions.

According to the first aspect described above, the sensing switch includes a micro-switch, and the sensing switch driving member includes an elastic button, the elastic button being elastically deformable in the first direction. where the sensing switch driving member is configured such that as the main slider drives the switch slider to move, the elastic button is able to be compressed and deformed by the switch slider to switch on the micro-switch, and is able to extend and restore to switch off the micro-switch.

According to the first aspect described above, the door lock further includes a cam and a locking pin. The cam is configured to receive the door hook and drive the main slider to move in the first direction. The locking pin is movable in a third direction to lock or release the main slider and the cam, where one end of the locking pin extends into the switch box to switch on the operating switch when the main slider and the cam are locked, or to switch off the operating switch when the main slider and the cam are released.

In a second aspect, the present disclosure provides an electrical appliance, including the door lock of any one of the implementations of the first aspect described above.

According to some specific implementations, the electrical appliance is a washing machine and/or a dishwasher.

Compared with prior arts, the door lock of the present disclosure includes the sensing circuit and the sensing switch to allow the electrical appliance to independently indicate the states of the door and the door hook of the electrical appliance, meeting more operational requirements of the electrical appliance and providing more possibilities for intelligent designs.

The sensing circuit and sensing switch of the door lock of the present disclosure are arranged outside the switch box and are separated from the operating circuit, which avoids both the high-voltage and the low-voltage power sources disposing inside the switch box, thereby improving the reliability of the sensing circuit and the operating circuit.

Other objectives and advantages of the present disclosure will be apparent from the following description of the present disclosure with reference to the drawings, which can contribute to a comprehensive understanding of the present disclosure.

### BRIEF DESCRIPTION OF SEVERAL VIEWS OF THE DRAWINGS

FIG. 1A is a structural perspective view of a door lock according to an embodiment of the present disclosure from one perspective;

FIG. 1B is a structural perspective view of the door lock shown in FIG. 1A from another perspective;

FIG. 1C is an exploded view of the door lock in FIG. 1B with a base removed;

FIG. 2A shows a structural perspective view of a cam, a slider mechanism, a locking pin, and a sensing circuit device in FIG. 1C from one perspective;

FIG. 2B shows a structural perspective view of the cam, the slider mechanism, the locking pin, and the sensing circuit device shown in FIG. 2A from another perspective;

FIG. 3A shows a structural perspective view of the sensing circuit device in FIG. 2A from one perspective;

FIG. 3B shows an exploded view of the sensing circuit device shown in FIG. 3A from another perspective;

FIG. 4A shows a top view of the door lock shown in FIG. 1C in a door open state;

FIG. 4B shows a top view of the door lock shown in FIG. 1C in a door closed state;

FIG. 5A shows a top view of a door lock according to another embodiment of the present disclosure in a door open state;

FIG. 5B shows a top view of the door lock shown in FIG. 5A in a door closed state;

FIG. 6A shows a circuit block diagram of an operating circuit in the door lock in FIG. 1A; and

FIG. 6B shows a circuit block diagram of a sensing circuit in the door lock in FIG. 1A.

Before the embodiments of the present disclosure are explained in detail, it is to be understood that the present disclosure is not limited in its application to the details of construction and the arrangement of the components set forth in the following description or illustrated in the drawings. The present disclosure is capable of other embodiments and of being practiced or being carried out in various ways. Moreover, it is to be understood that the phraseology and terminology used herein are for the purpose of description and should not be regarded as limiting. The use of “include” and “comprise” and variations thereof are intended to encompass the items listed thereafter and equivalents thereof as well as additional items and equivalents thereof.

### DESCRIPTION OF PREFERRED EMBODIMENTS

Various specific embodiments of the present disclosure will be described below with reference to the drawings which form part of this specification. It should be understood that although the terms for indicating directions, such as “front”, “rear”, “upper”, “lower”, “left”, “right”, “top”, “bottom”, “inner” and “outer”, are used in the present disclosure to describe various exemplary structural parts and elements of the present disclosure, these terms are used herein only for ease of illustration and are determined based on the exemplary orientations as shown in the accompanying drawing. Since the arrangements in the embodiments disclosed in the present disclosure may be in various directions, these terms indicating directions are only illustrative and should not be considered as limitations. If possible, the same or similar reference numerals used in the present disclosure refer to the same components.

Unless otherwise specified, raw materials used in the embodiments are commercially available industrial products and can be purchased commercially.

For ease of description of specific embodiments, in the present disclosure, a length direction of a door lock 100 is taken as an x direction (a first direction), a width direction of the door lock 100 is taken as a y direction (a second direction), and a height direction of the door lock is taken as a z direction (a third direction) for exemplary illustration.

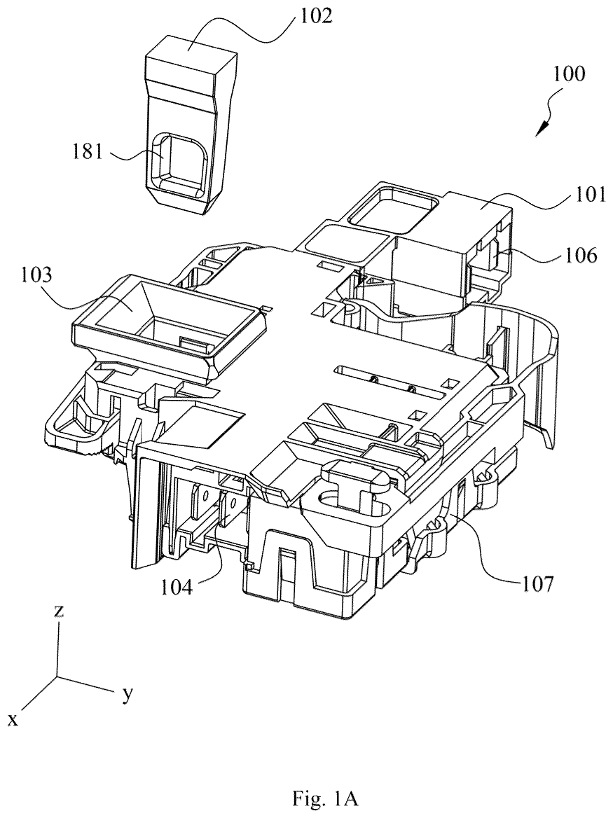

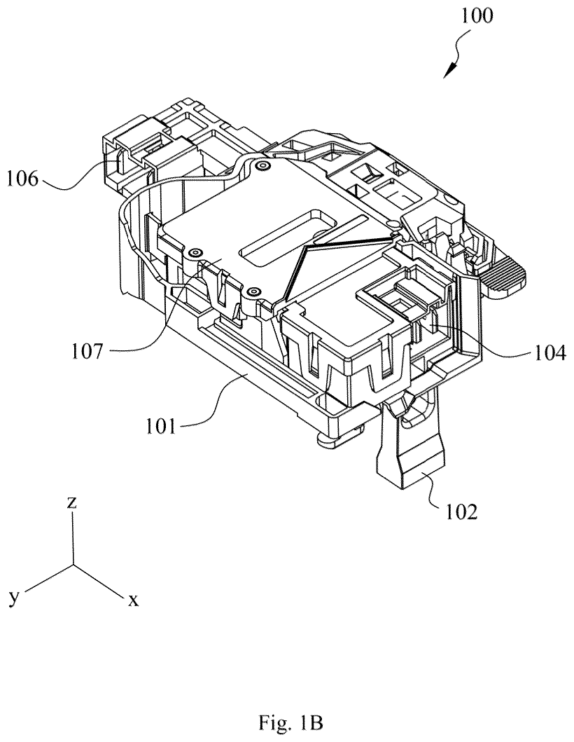

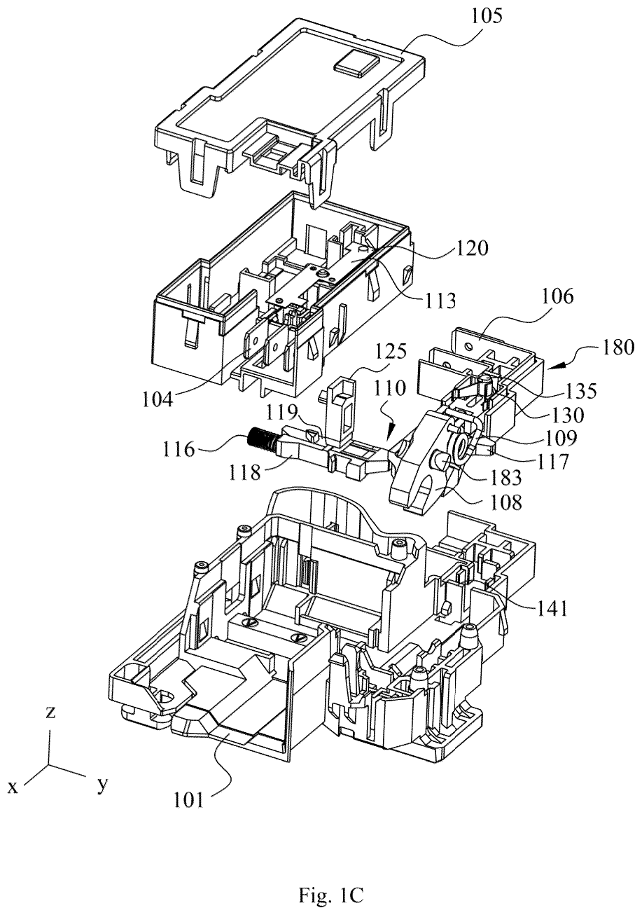

FIGS. 1A-1C show the general structure of the door lock 100. FIGS. 1A and 1B are structural perspective views of the door lock 100 from front and back perspectives, respectively, to show the external structure of the door lock 100. FIG. 1C is an exploded view of the door lock 100 with a base removed from a back perspective, to show the internal structure of the door lock 100. The door lock 100 includes a housing 101 located at an upper part and a base 107 below and engaging with the housing 101, and an accommodating cavity is created between the housing 101 and the base 107 for accommodating components of the door lock. A door lock hole 103 is provided on a left side of the housing 101, and the door lock hole 103 is configured to accommodate a door hook 102. In an example shown in FIGS. 1A-1C, the door hook 102 is located above the door lock hole 103, when a door of an electrical appliance (i.e., a washing machine) is opened or closed, the door hook 102 moves vertically in the z direction (i.e., the third direction) along with the door of the electrical appliance (e.g., a washing machine or a dishwasher) to exit or enter the door lock hole 103. When the door hook 102 is inserted into the interior of the door lock 100 through the door lock hole 103 in the front of the housing 101, a hole 181 of the door hook 102 engages with a cam 108 inside the door lock 100, and when the cam 108 is locked, the door of the electrical appliance is also locked.

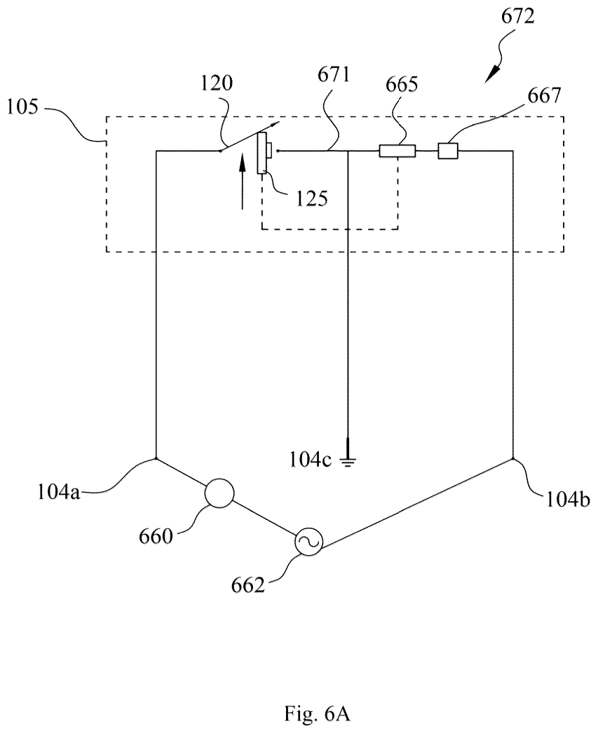

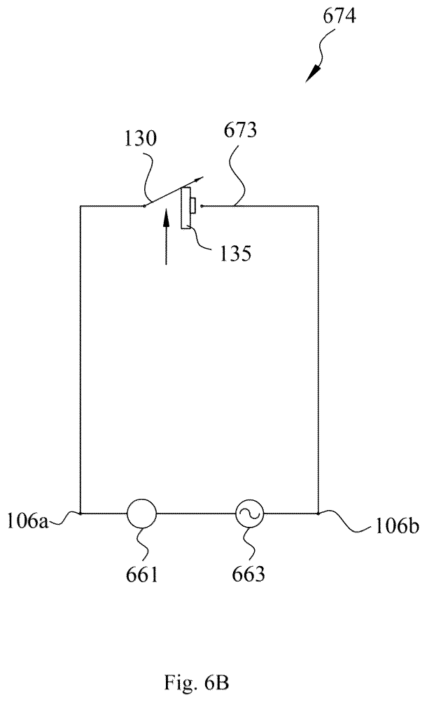

The door lock 100 further includes an operating circuit connecting end 104 and a sensing circuit connecting end 106. The operating circuit connecting end 104 is configured to connect the door lock 100 to an operating circuit (see an operating circuit 671 shown in FIG. 6A) to supply power to the electrical appliance by means of the operating circuit 671, enabling activation of the electrical appliance. The sensing circuit connecting end 106 is configured for connection to a sensing circuit (see a sensing circuit 673 shown in FIG. 6B) to sense whether the door hook 102 is inserted into the door lock hole 103 by means of the sensing circuit 673 and to provide a sensing indication accordingly. In this embodiment, the operating circuit connecting end 104 includes three connecting ends (see a connecting end 104a, a connecting end 104b, and a grounding end 104c in FIG. 6A), and the sensing circuit connecting end 106 includes two connecting ends (see a connecting end 106a and a connecting end 106b in FIG. 6B).

Further, as shown in FIG. 1C, the door lock 100 further includes the cam 108, a switch box 105, a locking pin 125, a slider mechanism 110, and a sensing circuit device 180. The cam 108 and the switch box 105 are arranged side by side in the y direction (i.e., the second direction) in the accommodating cavity between the housing 101 and the base 107 (not shown in FIG. 1C). The slider mechanism 110 cooperates with the cam 108 to hold and lock the cam 108 in its locked position. The locking pin 125 is arranged between the switch box 105 and the slider mechanism 110 to lock or release the slider mechanism 110 and to switch on or off an operating switch 120 in the switch box 105, thereby disconnecting or connecting the operating circuit. The sensing circuit device 180 cooperates with the slider mechanism 110 to close or open the sensing circuit based on the position and state of the slider mechanism 110.

Specifically, the cam 108 is located on the right side of the housing 101 (referring to FIG. 1A, on the left side of the housing 101, i.e., below the door lock hole 103). The door hook 102 can be received by the cam 108 via the door lock hole 103. When the door is closed, the door hook 102 is inserted into the door lock hole 103 from bottom to top in the z direction (referring to FIG. 1A, the door hook 102 is inserted into the door lock hole 103 from top to bottom), to push the cam 108 to rotate to its locked position. When the door is opened, the door hook 102 is pulled out from the door lock hole 103 from top to bottom in the z direction, by pulling the cam 108 to rotate away from its locked position until it reaches its released position.

The cam 108 is supported on the housing 101 by means of a rotation shaft 183 provided on two sides of the cam, and the cam 108 can perform a rotational movement around the rotation shaft 183. An elastic component 109 is mounted on a rear side of the cam 108, and the elastic component 109 applies a preload force on the cam 108 to drive or impede the rotation of the cam 108. The elastic component may be a torsion spring as shown in FIG. 1C, or a different elastic component. When the door is closed, an external force pushes the door hook 102, causing the door hook 102 to push the cam 108 to rotate, and the external force needing to overcome an elastic force of the torsion spring; and when the door is opened, in case of the cam 108 being not locked by the slider mechanism 110, the elastic force of the torsion spring drives the cam 108 to rotate to pop out the door hook 102.

A length of the switch box 105 is set in the x direction (i.e., the first direction). The switch box 105 is mounted on the left side of the housing 101 (referring to FIG. 1A, the switch box 105 is mounted on the right side of the housing 101). The operating switch 120 is arranged inside the switch box 105, and the operating switch 120 is connected to the operating circuit (see the operating circuit 671 shown in FIG. 6A) by means of the operating circuit connecting end 104. The switch box 105 mainly functions to control the movement of the locking pin 125 and to switch on or off the operating switch 120 based on the movement of the locking pin 125. The slider mechanism 110 can be locked or released by controlling the movement of the locking pin 125, and the cam 108 is locked or released by locking or releasing the slider mechanism 110. In this way, the switch box 105 can switch on or off the operating switch 120 while locking or releasing the cam 108. In this embodiment, the operating switch 120 includes a pair of elastic pieces 113, and the locking pin 125 can pass through the switch box 105 from below the switch box 105 and extend into the switch box 105 until coming into contact with one of the pair of elastic pieces 113. As the locking pin 125 moves in the z direction (i.e., the third direction), the locking pin 125 can move upwardly to lift one of the elastic pieces, causing the pair of elastic pieces 113 to be separated from each other, or move downwardly without applying a pushing force to the elastic pieces which allows the pair of elastic pieces 113 to be in contact with each other. When the pair of elastic pieces 113 are in contact with each other, the operating switch 120 is switched on, and when the pair of elastic pieces 113 are separated from each other, the operating switch 120 is switched off. Thus, the movement of the locking pin 125 in the z direction can switch on or off the operating switch 120.

The slider mechanism 110 includes a main slider 117 and a locking slider 118. The main slider 117 and the locking slider 118 are arranged perpendicular to each other, and an extension direction of the locking slider 118 is perpendicular to a rotation plane (i.e., an xz plane) of the cam 208. In this embodiment, the main slider 117 extends in the x direction, and the locking slider 118 extends in the y direction. The main slider 117 is arranged on the right side of the housing 101 (referring to FIG. 1A, on the left side of the housing 101) and is located adjacent to the cam 108 and can abut against the cam 108. The main slider 117 can move in the x direction as the cam 108 rotates. The locking slider 118 is arranged between the housing 101 and the switch box 105, and an end of the locking slider 118 is arranged adjacent to the main slider 117 and can come into contact with the main slider 117. When the main slider 117 moves in the x direction, the locking slider 118 can be driven to move in the y direction. When the locking slider 118 is locked out of movement, the main slider 117 is also locked out of movement, that is, the slider mechanism 110 is locked.

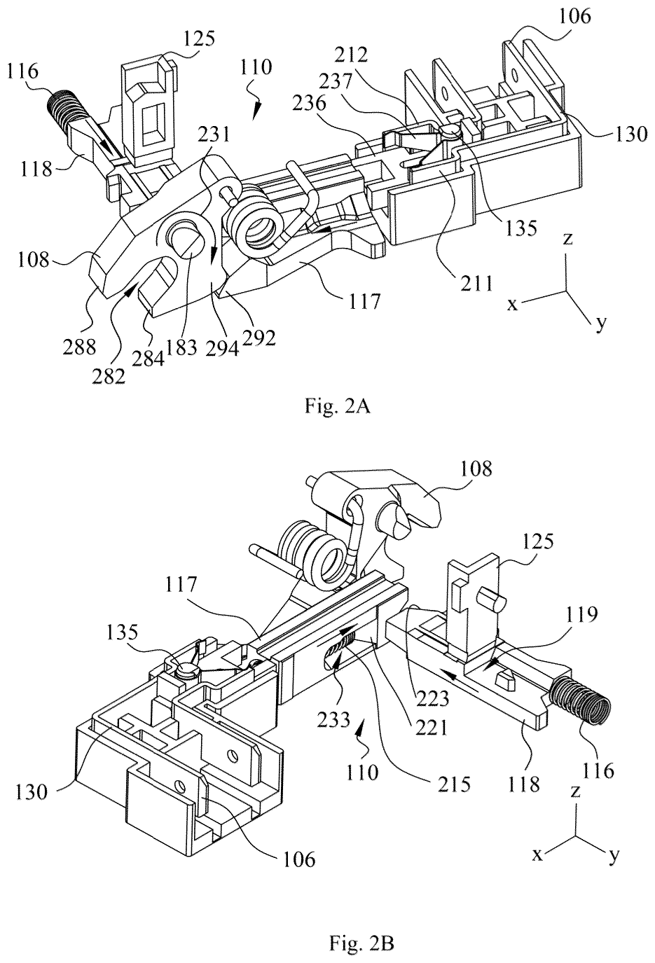

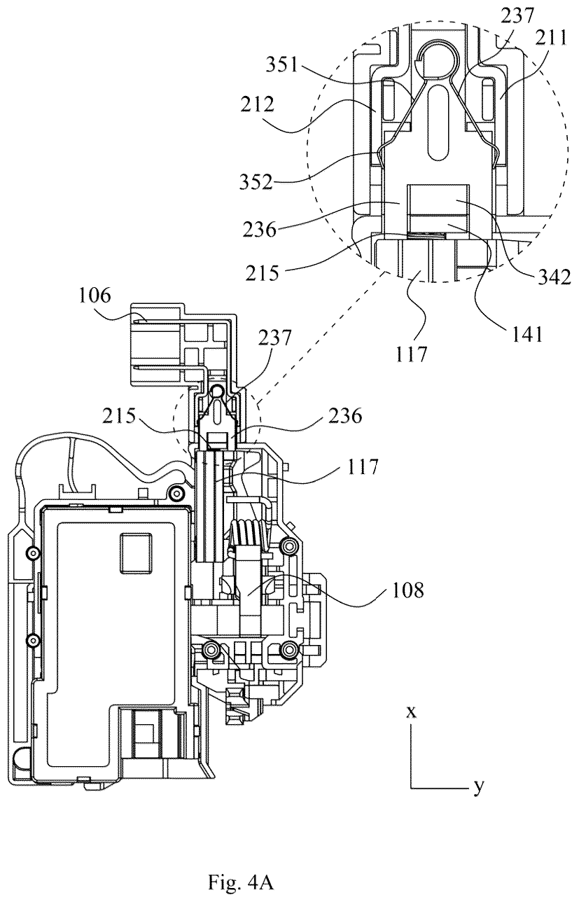

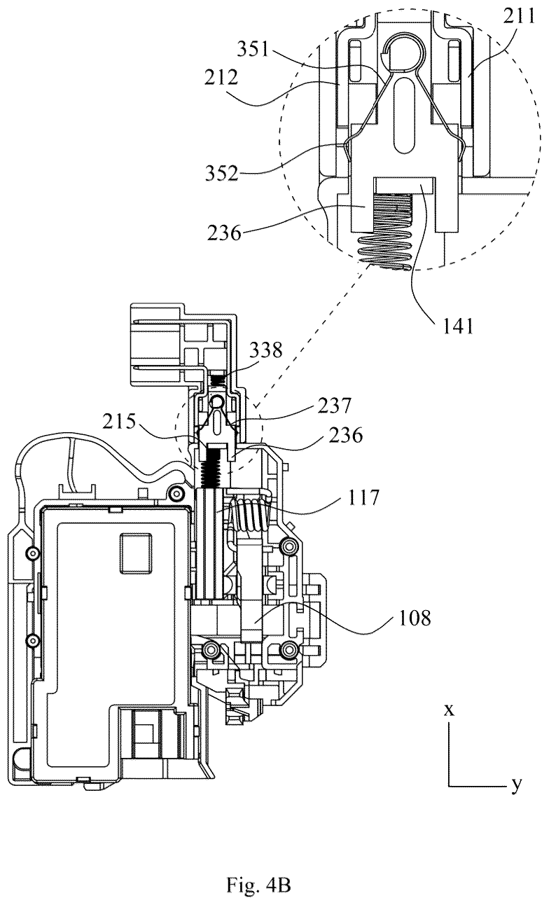

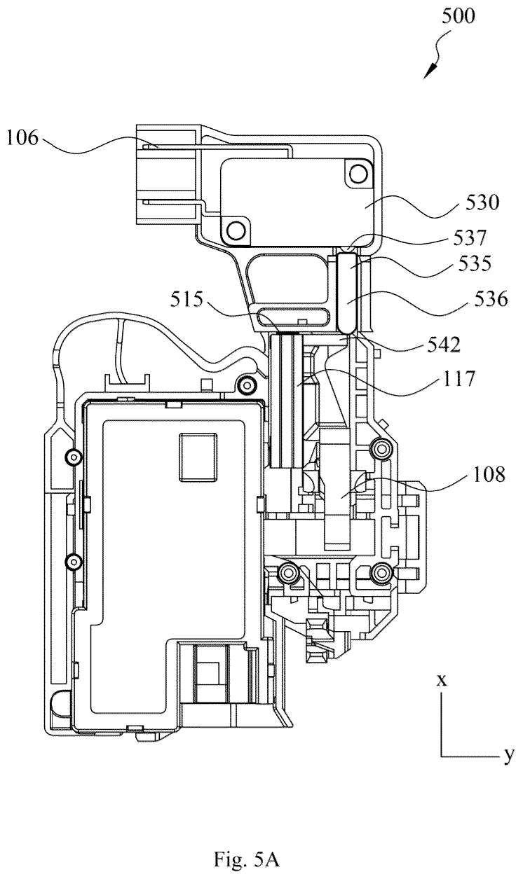

A spring 215 is connected to a tail end of the main slider 117 (see FIG. 2B), and a spring 116 is connected to a tail end of the locking slider 118. The spring 215 extends in the x direction, with one end of the spring 215 abutting against a tail portion of the main slider 117 and the other end abutting against an inner wall of the housing 101 (see FIGS. 4A and 4B) to apply a certain preload force on the main slider 117. The spring 116 extends in the y direction, with one end of the spring 116 abutting against a tail portion of the locking slider 118 and the other end also abutting against the inner wall of the housing 101 to apply a certain preload force on the locking slider 118. In this way, the main slider 117 can reciprocate in the x direction under the actions of the cam 108 and the spring 215, and the locking slider 118 can reciprocate in the y direction under the actions of the main slider 117 and the spring 116. It will be appreciated by those skilled in the art that the spring 215 and the spring 116 may be different elastic components that can provide a certain preload force.

A locking hole 119 is provided in the locking slider 118, and the locking hole 119 is configured to receive the locking pin 125. When the locking pin 125 moves downwardly in the z direction into the locking hole 119, the locking pin 125 can lock the locking slider 118, thereby locking the slider mechanism 110 and switching on the operating switch 120. When the locking pin 125 moves upwardly in the z direction to exit the locking hole 119, the locking pin 125 can release the locking slider 118, thereby releasing the slider mechanism 110 and switching off the operating switch 120. In this way, the locking pin 125 can lock or release the slider mechanism 110 and thus lock or release the cam 108 while switching on or off the operating switch 120. A more detailed movement process of the cam 108, the slider mechanism 110 and the locking pin 125 will be described below with reference to FIGS. 2A-2B.

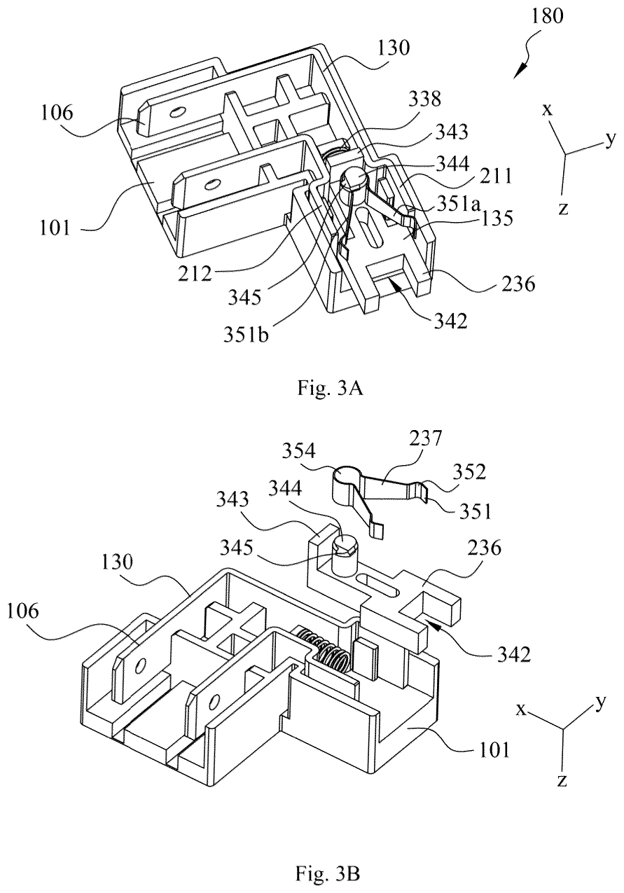

The sensing circuit device 180 includes a sensing switch 130 and a sensing switch driving member 135, the sensing switch driving member 135 being configured to switch on or off the sensing switch 130. The sensing switch 130 is connected to the sensing circuit (see the sensing circuit 673 shown in FIG. 6A) by means of the sensing circuit connecting end 106. In this embodiment, the sensing switch driving member 135 abuts against the main slider 117 for movement together with the main slider 117 in the x direction. Based on the position of the main slider 117, the sensing switch driving member 135 can come into contact with contact terminals (see a first contact terminal 211 and a second contact terminal 212 in FIGS. 3A and 3B) of the sensing switch 130 to switch on the sensing switch 130, or be separated from the contact terminals to switch off the sensing switch 130. A more detailed movement process of the sensing circuit device 180 will be described below with reference to FIGS. 3A-3B.

FIGS. 2A and 2B are structural perspective views of the cam, the slider mechanism, the locking pin and the sensing circuit device of the door lock 100 from two perspectives for illustrating their positional relationship and movement process. In FIGS. 2A and 2B, the door hook is in a pulled out (i.e., when the door is opened) position, the cam 108, the slider mechanism 110 and the locking pin 125 are each in their respective released positions, and the sensing switch driving member 135 is in its switch-on position so as to switch on the sensing switch 130. As shown in FIG. 2A, an open slot 282 is provided in the cam 108, the open slot 282 is configured to accommodate an end of the door hook 102, and the open slot 282 has an upper end 288 and a lower end 284. During insertion of the door hook 102 into the door lock hole 103, the door hook 102 pushes the cam 108 upwards. An outer side of the front end of the door hook 102 abuts against the upper end 288 of the open slot 282, and the further insertion of the door hook 102 causes the door hook 102 to push the cam 108 to rotate clockwise (i.e. in a direction of an arrow 231) around the rotation shaft 183, and in turn causes the lower end 284 of the open slot 282 to be inserted into the hole 181 of the door hook 102, thereby hooking the door hook 102, and at this point, the cam 108 reaches its locked position. During the process of the door hook 102 being pulled out from the door lock hole 103, the door hook 102 pulls the cam 108 downwards. An inner side of the front end of the door hook 102 abuts against the lower end 284 of the open slot 282, and the further pulling out of the door hook 102 causes the door hook 102 to pull the cam 108 to rotate counterclockwise (i.e. in a direction opposite the arrow 231) around the rotation shaft 183, and in turn causes the lower end 284 of the open slot 282 to leave the hole 181 of the door hook 102, and at this point, the cam 108 leaves its locked position until it reaches the released position as shown in FIG. 2A.

As shown in FIGS. 2A-2B, as the cam 108 rotates between its locked position and its released position, the slider mechanism 110 also moves between its locked position and its released position correspondingly. As an example, when the slider mechanism 110 is in the locked position, both the main slider 117 and the locking slider 118 are in the locked positions; and when the slider mechanism 110 is in the released position, both the main slider 117 and the locking slider 118 are in the released positions.

Specifically, the main slider 117 is arranged on the rear side of the cam 108, and a front end surface 292 of the main slider 117 is in contact with or abuts against a lower end surface 294 of the cam 108, such that the main slider 117 can move in the x direction as the cam 108 rotates. The locking slider 118 is located on a side of the main slider 117 and abuts against the main slider 117. The main slider 117 has a main slider bevel 221 on a side, the locking slider 118 has a locking slider bevel 223 at its head, and the main slider bevel 221 and the locking slider bevel 223 are complementary to each other, such that the locking slider 118 can move in the y direction as the main slider 117 moves.

The main slider 117 has a cavity for accommodating the spring 215, one end of the spring 215 abutting against an inner wall of the cavity of the main slider 117 and the other end abutting against the inner wall of the housing 101 (see FIGS. 4A and 4B). An opening 233 is formed in the side of the cavity of the main slider 117, and the main slider bevel 221 is arranged in the opening 233. When the main slider 117 moves in the x direction from its released position toward its locked position until the opening 233 is aligned to the head of the locking slider 118, the locking slider 118 moves in the y direction toward its locked position under the elastic force of the spring 116, such that the head of the locking slider 118 can extend into the opening 233. When the main slider 117 moves in the x direction from its locked position toward its released position, component forces generated on the main slider bevel 221 and the locking slider bevel 223 drive the locking slider 118 to move in the y direction from its locked position toward its released position, until the head of the locking slider 118 exits the opening 233 and abuts against a side wall of the main slider 117.

The locking pin 125 is located above the locking slider 118, and the locking pin 125 can reciprocate vertically in the z direction between its locked position and its released position. When the locking slider 118 is moved to its locked position, the locking pin 125 can be aligned to the locking hole 119 of the locking slider 118. When driven by the pair of elastic pieces 113 of the operating switch 120 to move downwardly to reach its locked position, the locking pin 125 can be inserted into the locking hole 119 to lock the locking slider 118, thereby preventing the slider mechanism 110 from moving. When the locking pin 125 moves upwardly to exit the locking hole 119 and reaches its released position, the locking slider 118 can be released.

Thus, based on the structure shown in FIG. 2A, in the case that the locking slider 118 is not locked by the locking pin 125, when the cam 108 rotates clockwise (i.e., the door hook 102 is inserted into the door lock hole 103), the cam 108 rotates from the released position to the locked position, the lower end surface 294 of the cam 108 moves away from the front end surface 292 of the main slider 117, and the elastic force generated by the spring 215 overcomes the elastic force of the torsion spring on the cam 108 to push the main slider 117 to move from the released position to the locked position in the x direction (i.e., move to the left in FIG. 2A); and when the cam 108 rotates counterclockwise (i.e., the door hook 102 exits the door lock hole 103), the cam 108 rotates from the locked position to the released position, the lower end surface 294 of the cam 108 applies a force on the front end surface 292 of the main slider 117 to push the main slider 117 to move from its locked position to its released position in the x direction (i.e. move to the right in FIG. 2A), and the movement of the main slider 117 compresses the spring 215.

Similarly, based on the structure shown in FIG. 2B, in the case that the locking slider 118 is not locked by the locking pin 125, when the main slider 117 moves from its released position to its locked position in the x direction (i.e., moves to the right in FIG. 2B), the opening 233 of the main slider 117 is aligned to the head of the locking slider 118, and the elastic force generated by the spring 116 causes the head of the locking slider 118 to extend into the opening 233 of the main slider 117 and pushes the locking slider 118 to move from its released position to its locked position in the y direction (i.e., move forward in FIG. 2B); and when the main slider 117 moves from its locked position to its released position in the x direction (i.e., moves to the left in FIG. 2B), the main slider bevel 221 of the main slider 117 applies a force on the complementary locking slider bevel 223 of the locking slider 118, component forces generated by the two complementary bevels cause the locking slider 118 to move from its locked position to its released position in the x direction (i.e., move backwardly in FIG. 2B), the head of the locking slider 118 exits the opening 233 of the main slider 117, and the movement of the locking slider 118 compresses the spring 116.

In this way, when the locking slider 118 and the main slider 117 are in their respective locked positions, the cam 108 is also in a position where it can be locked. In this case, if the locking pin 125 moves downwardly to enable the bottom of the locking pin 125 to be inserted into the locking hole 119 (i.e., reaches the locked position of the locking pin), the locking slider 118 is locked, and the main slider 117 and the cam 108 are locked accordingly, such that the door hook 102 is also locked in the cam 108, and the door hook 102 cannot be pulled out. In this case, if the bottom of the locking pin 125 exits the locking hole 119 (i.e., leaves the locked position of the locking pin), even if the locking slider 118 and the main slider 117 are in the locked positions, since the locking slider 118 is not locked by the locking pin 125, the main slider 117 can still push the cam 108 to the locked position, and thus the door hook 102 can still be pulled out from the cam 108. The pulling out of the door hook 102 enables the movements of the main slider 117 and the locking slider 118 from their respective locked positions to the released positions.

Thus, in the present disclosure, by means of the transfer action of the main slider 117 and the locking slider 118, the rotational movement of the cam 108 can be transformed into a linear movement of the main slider 117 in the x direction and a linear movement of the locking slider 118 in the y direction, which achieves easier control over the locking for the cam 108 (e.g., by means of the locking pin 125 to lock or release the locking slider 118 to control the cam 108), and also achieves a compact size and a square shape, further reducing the length of the door lock 100. Moreover, the requirements for the accuracy and strength of the slider mechanism 110 are reduced. It should be noted that the present disclosure is also applicable to an embodiment in which the locking hole is provided directly in the main slider, as long as the position of the locking pin is set accordingly.

The sensing switch driving member 135 is arranged on the rear side of the main slider 117. In this embodiment, the sensing switch driving member 135 includes a switch slider 236 and an elastic piece 237. The switch slider 236 moves in response to the movement of the main slider 117 between its locked position and its released position. The elastic piece 237 is connected to the switch slider 236 and moves with the movement of the switch slider 236. In this embodiment, a front end of the switch slider 236 abuts against a rear end surface of the main slider 117. A spring 338 (see FIG. 3A) is connected to a rear end of the switch slider 236. The spring 338 extends in the x direction, with one end of the spring 338 abutting against the rear end of the switch slider 236 and the other end abutting against the inner wall of the housing 101 to apply a certain preload force on the switch slider 236. In this way, the switch slider 236 and the elastic piece 237 can reciprocate in the x direction with the movement of the main slider 117 in the x direction under the actions of the main slider 117 and the spring 338. It will be appreciated by those skilled in the art that the spring 338 may be a different elastic component that can provide a certain preload force. And in other embodiments, the sensing switch driving member 135 also be provided as a different structure, as long as a corresponding movement can be performed in response to the position of the main slider 117.

The sensing switch 130 includes a first contact terminal 211 and a second contact terminal 212, tail ends of the first contact terminal 211 and the second contact terminal 212 forming the sensing circuit connecting end 106. When the main slider 117 is in the released position as shown in FIGS. 2A and 2B, the switch slider 236 and the elastic piece 237 of the sensing switch driving member 135 are in their switch-on positions, the elastic piece 237 can come into contact with the first contact terminal 211 and the second contact terminal 212 to switch on the sensing switch 130. When the main slider 117 moves in the x direction to its locked position, the switch slider 236 of the sensing switch driving member 135 is moved forward in the x direction to its switch-off position under the elastic force of the spring 338, such that the elastic piece 237 moves away from the first contact terminal 211 and the second contact terminal 212, thereby switching off the sensing switch 130. In this embodiment, the elastic piece 237 is a V-shaped elastic piece. A pair of legs of the elastic piece 237 are configured for contact with the first contact terminal 211 and the second contact terminal 212, respectively. A maximum distance between the pair of legs of the elastic piece 237 is less than a distance between the first contact terminal 211 and the second contact terminal 212, such that when the sensing switch driving member 135 is in the switch-on position, the pair of legs of the elastic piece 237 can be forced and deformed by corresponding contact terminals, thereby achieving a holding force between the elastic piece 237 and the corresponding contact terminals. It will be understood by those skilled in the art that the elastic piece may be configured in any other shape as long as it can come into contact with or be separated from the contact terminals of the sensing switch 130 with the movement of the switch slider 236.

In this embodiment, since the main slider 117 moves with the rotation of the cam 108, the position of the main slider 117 reflects the position of the cam 108 and thus the position of the door hook 102 and the state of the door of the electrical appliance. In addition, the sensing switch driving member 135 can move with the movement of the main slider 117 to switch on or off the sensing switch 130. Thus, the switch-on or switch-off of the sensing switch 130 can reflect the position of the door hook 102 and the state of the door of the electrical appliance.

FIGS. 3A and 3B are structural perspective views of the sensing circuit device from two perspectives for illustrating the specific structure of the sensing circuit device. In the state shown in FIGS. 3A and 3B, the sensing switch driving member 135 is in its switch-off position to switch off the sensing switch 130. As shown in FIGS. 3A and 3B, the switch slider 236 is substantially in the form of an elongated block extending in the x direction and moves in the x direction. The switch slider includes a blocking wall 343 arranged at its top end and a recess 342 arranged at its bottom end in its extension direction. The blocking wall 343 is configured for connection to the spring 338 to more stably accept an acting force of the spring 338. In this embodiment, the blocking wall 343 is formed by extending vertically from the top of the switch slider 236, and is shaped and sized to match a corresponding portion of the housing 101 to enable the spring 338 to be connected between the inner wall of the housing 101 and the blocking wall 343, so as to apply an elastic force to the switch slider 236 by means of the blocking wall 343. The recess 342 is configured to allow a blocking wall 141 (see FIG. 1C) on the inner wall of the housing 101 to slide in the recess 342 so as to limit the switch-on position and the switch-off position of the switch slider 236. In this embodiment, the recess 342 is formed by transversely recessing from the bottom of the switch slider 236 and is shaped and sized to match the blocking wall 141 (see FIG. 1C), such that when the switch slider 236 is in its switch-on position, two outer side portions of the recess 342 can abut against the main slider 117. And, when the switch slider 236 moves from the switch-on position to its switch-off position, the recess 342 provides a space for movement of the blocking wall 141 until the blocking wall 141 abuts against the bottom of the recess 342, thereby limiting the switch slider 236 in its switch-off position.

A vertically extending support post 344 is provided on a side of the switch slider 236 close to the blocking wall 343. The support post 344 is configured for connection to the elastic piece 237. The support post 344 may be provided in any shape matching the elastic piece 237 such that the elastic piece 237 does not displace relative to the switch slider 236. In this embodiment, the support post 344 is substantially cylindrical and has a tab 345 extending radially outward at the top end thereof, the tab 345 being configured to catch the elastic piece 237 from above, thereby holding the elastic piece 237 in place.

The elastic piece 237 includes a cylindrical cylinder portion 354, and a pair of legs 351 extend downwardly and outwardly from two ends of the cylinder portion 354 to form free ends, thereby forming a substantially V-shaped elastic piece 237. The cylinder portion 354 is configured to be sleeved on the support post 344 of the switch slider 236, and the tab 345 abuts against an upper surface of the cylinder portion 354, such that the elastic piece 237 is connected to the switch slider 236 by means of the support post 344, and the pair of legs 351 form free ends. Thus, the pair of legs 351 can elastically deform to expand outwardly or contract inwardly. In the x direction (i.e., from the cylinder portion 354 to the free end), a distance between the pair of legs 351 of the elastic piece 237 generally increases gradually. The elastic piece 237 is positioned substantially between the first contact terminal 211 and the second contact terminal 212. In this embodiment, the distance between the pair of legs 351 (i.e., the distance in the y direction) is set such that the maximum distance is greater than the distance between the first contact terminal 211 and the second contact terminal 212, and the minimum distance is less than the distance between the first contact terminal 211 and the second contact terminal 212. The first contact terminal 211 and the second contact terminal 212 are configured to have a suitable length in the x direction, such that as the elastic piece 237 moves in the x direction, the pair of legs 351 can abut against corresponding contact terminals or be separated from each contact terminal. In this embodiment, the pair of legs 351 include a first leg 351a and a second leg 351b, each of the first leg 351a and the second leg 351b having one end connected to the cylinder portion 354 and the other end forming a free end. The first leg 351a and the second leg 351b can elastically deform to enable the respective free ends move toward each other or away from each other. The first leg 351a is configured to abut against the first contact terminal 211, and the second leg 351b is configured to abut against the second contact terminal 212. As the elastic piece 237 moves in the x direction, the first leg 351a and the second leg 351b synchronously come into contact with or be separated from the first contact terminal 211 and the second contact terminal, respectively. In this embodiment, the pair of legs 351 each further have an outwardly arched arch portion 352 near the free end, the arch portion 352 being substantially in the form of a circular arc, such that the elastic piece 237 can come into contact with the first contact terminal 211 and the second contact terminal 212 at the arch portions 352.

The first contact terminal 211 and the second contact terminal 212 are in the form of a sheet having corners, and are arranged spaced apart from each other. Portions of the first contact terminal 211 and the second contact terminal 212 close to the sensing switch driving member 135 extend in the x direction to come into contact with or be separated from the elastic piece 237. The other portions of the first contact terminal 211 and the second contact terminal 212 extend in the y direction to form the sensing circuit connecting end 106. The first contact terminal 211 and the second contact terminal 212 are configured in a cornered shape to reduce the length of the door lock 100 in the x direction, facilitating the mounting of the door lock 100 to a panel of an electrical appliance.

In the present disclosure, the elastic piece 237, the first contact terminal 211, and the second contact terminal 212 are all made of a metal material having good electrical conductivity, such that when the elastic piece 237 comes into contact with the first contact terminal 211 and the second contact terminal 212, a current can be conducted, thereby connecting the sensing circuit.

FIGS. 4A and 4B are top views of the door lock in a door open state and a door closed state, respectively, for illustrating the principle of sensing of the sensing circuit device. FIG. 4A shows a top view of the door lock 100 with a base removed in the door open state (i.e., when the door hook 102 is not inserted into the door lock 100). FIG. 4B shows a top view of the door lock 100 with the base removed in the door closed state (i.e., when the door hook 102 is inserted into the door lock 100).

As shown in FIG. 4A, when the door of the electrical appliance is opened, the cam 108, the main slider 117, and the locking slider 118 are all in the released positions. The main slider 117 is in the uppermost position shown in FIG. 4A, and the spring 215 is compressed so as to apply an elastic force on the main slider 117 to push the main slider 117 to move downwardly. The locking pin 125 is also in the released position, causing the locking pin 125 to switch off the operating switch 120.

The sensing switch driving member 135 is in the switch-on position. The switch slider 236 abuts against a top end surface of the main slider 117, and as the main slider 117 moves to its uppermost position, the spring 338 is compressed (in FIG. 3A, the spring 338 is blocked by the switch slider 236) so as to apply an elastic force to the switch slider 236 to push the switch slider 236 to move downwardly. The blocking wall 141 of the housing 101 is located at an opening of the recess 342 of the switch slider 236 and thus does not block the switch slider 236 from moving downwardly. The elastic piece 237 is also moved to the uppermost position accordingly. The arch portions 352 of the pair of legs 351 of the elastic piece 237 come into contact with the first contact terminal 211 and the second contact terminal 212, respectively, to electrically connect the first contact terminal 211 to the second contact terminal 212, such that the sensing switch 130 is switched on. Since the maximum distance between the legs 351 of the elastic piece 237 is less than the distance between the first contact terminal 211 and the second contact terminal 212, the legs 351 of the elastic piece 237 are squeezed and deformed to be in a contracted deformation state, and the legs 351 apply a pressure force on corresponding contact terminals, causing the arch portions 352 to be in contact with the corresponding contact terminals.

At this point, if the door hook 102 is inserted into the door lock 100, the cam 108 will rotate toward the locked position, the spring 215 will push the main slider 117 to move toward the locked position, and the locking slider 118 also moves toward the locked position (i.e., moves to the right) under the elastic force of the spring 116, aligning the locking pin 125 to the locking hole 119.

As shown in FIG. 4B, the cam 108, the main slider 117, and the locking slider 118 are all in the locked positions. The main slider 117 is pushed to move downwardly by the spring 215 to the lowermost position shown in FIG. 4B. At this point, the locking pin 125 can move to the locked position in the locking hole 119, causing the locking pin 125 to switch on the operating switch 120.

The sensing switch driving member 135 is in the switch-off position. The switch slider 236 is pushed by the spring 338 to move downwardly to its lowermost position. The blocking wall 141 of the housing 101 abuts against the bottom (i.e., the topmost portion) of the recess 342 of the switch slider 236, such that the switch slider 236 cannot continue moving downwardly. The elastic piece 237 is also moved to the lowermost position accordingly. The pair of legs 351 of the elastic piece 237 move away from the first contact terminal 211 and the second contact terminal 212, and a narrower portion between the pair of legs 351 is located between the first contact terminal 211 and the second contact terminal 212, but is not in contact with the first contact terminal 211 and the second contact terminal 212, such that the first contact terminal 211 and the second contact terminal 212 are no longer electrically connected, thereby switching off the sensing switch 130.

In this way, the cam 108 and the main slider 117 can move to different positions with the door hook and the door in different states, such that the sensing switch 130 is switched on or off, thereby disconnecting or connecting the sensing circuit.

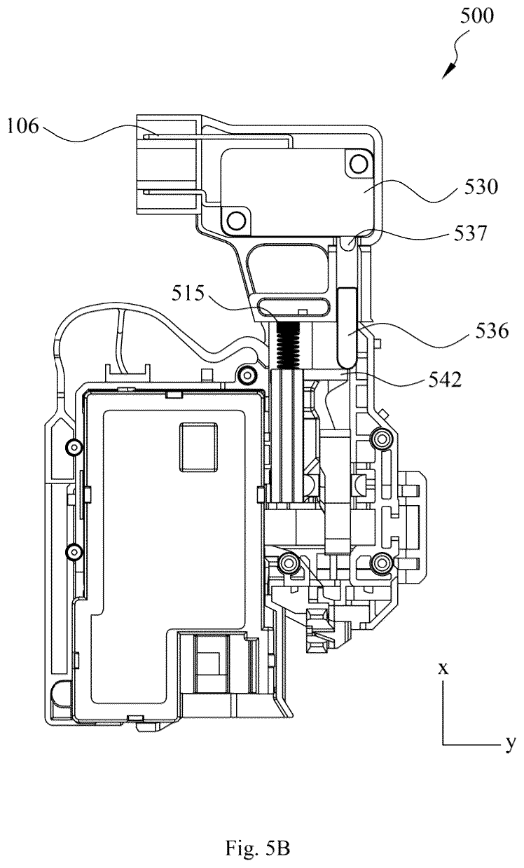

FIGS. 5A and 5B show a structure of a door lock 500 according to another embodiment of the present disclosure, and FIGS. 5A and 5B are top views of the door lock in a door open state and a door closed state, respectively. FIG. 5A shows a top view of the door lock 500 with a base removed in the door open state (i.e., when the door hook 102 is not inserted into the door lock 500). FIG. 5B shows a top view of the door lock 500 with the base removed in the door closed state (i.e., when the door hook 102 is inserted into the door lock 500). As shown in FIGS. 5A and 5B, the structure of the door lock 500 is substantially the same as that of the door lock 100, except that the structures of the sensing switch 530 and the sensing switch driving member 535 are different from those of the sensing switch 130 and the sensing switch driving member 135. Specifically, in this embodiment, the sensing switch 530 includes a micro-switch, which is electrically connected to the sensing circuit connecting end 106 to close or open the sensing circuit by switching on or off the micro-switch. The sensing switch driving member 535 includes a switch slider 536 and an elastic button 537. The elastic button 537 is configured to switch on or off the micro-switch. The elastic button 537 has a certain elasticity and can be compressed and deformed or extend and restore in the x direction. When the elastic button 537 is compressed and deformed, the micro-switch can be switched on, and when the elastic button 537 extends and restores, the micro-switch can be switched off. A top end of the switch slider 536 abuts against the bottom of the elastic button 537, and a bottom end of the switch slider 536 abuts against the main slider 117. As the main slider 117 moves between the released position and the locked position in the x direction, the switch slider 536 can also move between a switch-on position and a switch-off position, and the sensing switch 530 is switched on or off by means of the elastic button 537. In this embodiment, a blocking wall 542 extending in the y direction is provided at the top end of the main slider 117, and a bottom end of the switch slider 536 is able to abut against the blocking wall 542 of the main slider 117. The structures of the cam, the locking slider, the switch box, and the locking pin of the door lock 500 is the same as that of the door lock 100, and will not be described again.

As shown in FIG. 5A, when the door of the electrical appliance is opened, the cam 108, the main slider 117, and the locking slider are all in the released positions. The main slider 117 is in the uppermost position shown in FIG. 5A, and the spring 515 is compressed so as to apply an elastic force on the main slider 117 to force the main slider 117 to move downwardly. The locking pin is also in the released position, causing the locking pin to switch off the operating switch.

The sensing switch driving member 535 is in the switch-on position. The switch slider 536 abuts against the top end surface of the main slider 117, and as the main slider 117 moves to its uppermost position, the elastic button 537 is compressed and deformed, so as to apply an elastic force to the switch slider 536 to force the switch slider 536 to move downwardly. The elastic button 537, which is compressed and deformed, can switch on the micro-switch of the sensing switch 530.

At this point, if the door hook 102 is inserted into the door lock 100, the cam 108 will rotate toward the locked position, the spring 515 will force the main slider 117 to move toward the locked position, and the locking slider also moves toward the locked position (i.e., moves to the right) under the elastic force of the spring, aligning the locking pin to the locking hole.

As shown in FIG. 5B, the cam 108, the main slider 117 and the locking slider are all in the locked positions. The main slider 117 is pushed by the spring 515 to move downwardly to the lowermost position shown in FIG. 5B. At this point, the locking pin can move to the locked position in the locking hole, causing the locking pin to switch on the operating circuit.

The sensing switch driving member 535 is in the switch-off position. The switch slider 536 is pushed by the elastic button 537 to move down to its lowermost position. The elastic button 537 can be extended to a restored state to switch off the micro-switch of the sensing switch 530. The micro-switch of the sensing switch 530 is switched on again only when the main slider 117 forces the switch slider 536 to press the elastic button 537.

In this way, the cam 108 and the main slider 117 can move to different positions with the door hook and the door in different states, such that the sensing switch 530 can also be switched on or off, thereby disconnecting or connecting the sensing circuit. Compared with the door lock 100, the micro-switch of the door lock 500 according to this embodiment can be available commercially.

FIGS. 6A and 6B show block circuit diagrams of the door lock 100 shown in FIG. 1A. FIG. 6A shows a circuit block diagram of an operating loop 672, and FIG. 6B shows a circuit block diagram of a sensing loop 674.

As shown in FIG. 6A, the operating loop 672 includes the operating circuit 671. The operating switch 120 is arranged in the operating circuit 671 in the switch box 105. The operating switch 120 can close or open the operating circuit 671 to close or open the operating loop 672. Specifically, the connecting end 104a and the grounding end 104c of the operating circuit connecting end 104 are connected by the operating switch 120. The connecting end 104b and the grounding end 104c of the operating circuit connecting end 104 are connected by an electromagnet 665 and an electronic activation device 667. The electromagnet 665 and the electronic activation device 667 are also located in the switch box 105. The connecting end 104a and the connecting end 104b of the operating circuit connecting end 104 are connected in series with an electric motor 660 (or other driving components, such as a motor) and a power source 662. The electronic activation device 667 receives an electronic pulse signal and drives the locking pin 125 to move vertically by means of the electromagnet 665. The vertical movement of the locking pin 125 can control the switch-off or switch-on of the operating switch 120 and can lock or release the slider mechanism 110 and the cam 108. The switch-on or switch-off of the operating switch 120 is configured to control the disconnecting or connecting of the operating loop 672, thereby controlling the connection or disconnection between the electric motor 660 and the power source 662, and further controlling whether the electrical appliance can operate. In the present disclosure, the power source 662 is a high-voltage power source. In this embodiment, the power source 662 has a voltage of 220 V.

As shown in FIG. 6B, the sensing loop 674 includes the sensing circuit 673. The sensing switch 130 is located in the sensing circuit 673 outside the switch box 105. The sensing switch 130 can close or open the sensing circuit 673 to close or open the sensing loop 674. Specifically, the connecting end 106a and the connecting end 106b of the sensing circuit connecting end 106 are connected by the sensing switch 130. In some embodiments, the connecting end 106a and the connecting end 106b can be connected in series with an indicating device 661 and a power source 663 in the sensing loop 674. The switch-on or switch-off of the sensing switch 130 is configured to control the disconnecting or connecting of the sensing loop 674, thereby controlling the connection or disconnection between the indicating device 661 and the power source 663, and further indicating the state of the door by means of the indicating device 661. In some embodiments, the indicating device 661 may be a visual indicating device such as a light, or an audible indicating device such as a bell. In the present disclosure, the power source 663 is a low-voltage power source. In this embodiment, the power source 663 has a voltage of 5 V.

In the present disclosure, arranging the sensing circuit 673 and the sensing switch 130 outside the switch box 105 can avoid the arrangements of both the high-voltage and low-voltage circuits inside the switch box 105.

The door lock of the present disclosure includes the sensing circuit and the sensing switch, allowing the electrical appliance to independently indicate the states of the door and the door hook of the electrical appliance, meeting more operational requirements of the electrical appliance and providing more possibilities for intelligent designs.

The sensing circuit and sensing switch of the door lock of the present disclosure are arranged outside the switch box and are separated from the operating circuit, which avoids the arrangements of both high-voltage and low-voltage power sources inside the switch box, thereby improving the reliability of the sensing circuit and the operating circuit.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

1. A door lock comprising:
a main slider driven by a door hook to reciprocate in a first direction;
an operating circuit and an operating switch, the operating switch connecting or disconnecting the operating circuit based on a position of the main slider;
a sensing circuit and a sensing switch, the sensing switch connecting or disconnecting the sensing circuit based on the position of the main slider; and
a switch box, the operating circuit and the operating switch disposed inside the switch box, and the sensing circuit and the sensing switch disposed outside the switch box.

2. The door lock according to claim 1, further comprising:
a power source of the operating circuit is a high-voltage power source, and a power source of the sensing circuit is a low-voltage power source.

3. The door lock according to claim 1, wherein:
the main slider has a locked position and a released position; and
the door lock further comprises a sensing switch driving member configured to switch on the sensing switch in response to the main slider in the released position, thereby connecting the sensing circuit; and
to switch off the sensing switch in response to the main slider in the locked position, thereby disconnecting the sensing circuit.

4. The door lock according to claim 3, wherein:
the main slider reciprocates in the first direction between the locked position and the released position, and the sensing switch driving member comprises a switch slider;
wherein the main slider drives the switch slider to move in the first direction.

5. The door lock according to claim 4, wherein:
the sensing switch comprises a first contact terminal and a second contact terminal, and the sensing switch driving member comprises an elastic piece made of a conductive material; and
the elastic piece being connected to the switch slider to move in the first direction with the switch slider;
wherein the sensing switch driving member is configured such that as the main slider drives the switch slider to move, the elastic piece comes into contact with the first contact terminal and the second contact terminal to conduct the first contact terminal and the second contact terminal; or
the elastic piece moves away from at least one of the first contact terminal and the second contact terminal to disconnect the first contact terminal and the second contact terminal.

6. The door lock according to claim 5, wherein:
the elastic piece comprises a pair of legs being formed by obliquely extending away from each other in the first direction;
wherein a distance between the pair of legs in a second direction is set such that a maximum distance is greater than a distance between the first contact terminal and the second contact terminal, and a minimum distance is less than the distance between the first contact terminal and the second contact terminal.

7. The door lock according to claim 6, wherein:
each leg of the pair of legs further comprises an arch portion, the arch portion of each leg of the pair of legs arching in opposite directions, wherein the elastic piece is configured to contact with the first contact terminal and the second contact terminal at the arch portions.

8. The door lock according to claim 4, wherein:
the sensing switch comprises a micro-switch, and the sensing switch driving member comprises an elastic button elastically deformable in the first direction;
wherein the sensing switch driving member is configured such that the elastic button is compressed and deformed by the switch slider to switch on the micro-switch, and extends and restores to switch off the micro-switch as the main slider drives the switch slider to move.

9. The door lock according to claim 1, further comprising:
a cam configured to receive the door hook and drive the main slider to move in the first direction; and
a locking pin movable in a third direction to lock or release the main slider and the cam, wherein one end of the locking pin extends into the switch box to switch on the operating switch when the main slider and the cam are locked, or to switch off the operating switch when the main slider and the cam are released.

10. An electrical appliance, comprising the door lock of claim 1.
